(19) United States
(12) Patent Application Publication
(10) Pub. No.: US 2013/0346329 A1
(43) Pub. Date: Dec. 26, 2013

(54) SYSTEM AND METHODS FOR SOCIAL DATA SHARING CAPABILITIES FOR ENTERPRISE INFORMATION SYSTEMS

(71) Applicant: NETSUITE INC., (US)

(72) Inventors: Cherry Ann Alib-Bulatao, Paranaque City (PH); Teddy T. Caguioa, Meycauayan Bulacan (PH); Evan Mark Goldberg, Woodside, CA (US); Brad Stoutimore, San Francisco, CA (US)

(21) Appl. No.: 13/893,053

(22) Filed: May 13, 2013

Related U.S. Application Data
(60) Provisional application No. 61/646,381, filed on May 14, 2012.

(51) Int. Cl. G06Q 50/00; G06Q 10/06

(52) U.S. Cl. CPC G06Q 50/01; G06Q 10/06
USPC 705/319

(57) ABSTRACT

Systems and methods for enabling a display of updates to enterprise information in a social feed are described herein. A social subscription component receives instructions from a user pertaining to an enterprise information system entity and creates an enterprise information update rule or conditions corresponding to the instructions. A social data storage component stores the enterprise information update rule. A social content generation component monitors updates to data stored in an enterprise information system, tests any updates against the enterprise information update rule(s), if applicable accesses data related to those updates, and generates social posts pertaining to the updates for display to the user. A social user interface component may format and presents the social posts to the user.

### CROSS-REFERENCE TO RELATED APPLICATION

This application claims the benefit of U.S. Provisional Application No. 61/646,381, entitled “Enterprise Information Subscriptions for Social Applications,” filed May 14, 2012, which is incorporated by reference in its entirety (including Appendices) herein for all purposes.

### BACKGROUND

In addition to the advantages related to customer access created by the Internet, the ability of business users to access crucial business information has been greatly enhanced by the proliferation of IP-based networking together with advances in object oriented Web-based programming and browser technology. Using these advances, systems have been developed that permit web-based access to business information systems, thereby allowing any user with a browser and an Internet or intranet connection to view, enter, or modify the required business information. For example, substantial efforts have been directed to Enterprise Resource Planning (ERP) systems that integrate the capabilities of several historically separate business computing system into a common system, with a view toward streamlining business processes and increasing efficiencies on a business-wide level. By way of example, the capabilities or modules of an ERP system may include: accounting, order processing, time and billing, inventory management, employee management/payroll, and employee calendaring and collaboration, as well as reporting and analysis capabilities relating to these functions.

In a related movement, substantial efforts have also been directed to integrated Customer Relationship Management (CRM) systems, with a view toward obtaining a better understanding of customers, enhancing service to existing customers, and acquiring new, profitable customers. By way of example, the capabilities or modules of a CRM system may include: sales force automation (SFA), marketing automation, contact list management, call center support, and web-based customer support, as well as reporting and analysis capabilities relating to these functions. With differing levels of overlap with ERP/CRM initiatives and with each other, substantial efforts have also been directed toward development of increasingly integrated partner and vendor management systems, eCommerce systems, product lifecycle management (PLM) systems, and supply chain management (SCM) systems.

FIG. 1 is a diagram illustrating elements of an example computing environment 100 in which an exemplary embodiment of the inventive system and methods may be implemented. As shown in the figure, a variety of client applications (not shown) incorporating and/or incorporated into a variety of client computing devices 104 may communicate with a multi-tenant enterprise information system 108 through one or more networks 112. Examples of suitable client computing devices 104 include personal computers, server computers, desktop computers, laptop computers, notebook computers, personal digital assistants (PDAs), smart phones, cell phones, computers, and consumer electronics incorporating one or more computing device components, such as one or more electronic processors that may be programmed to execute a set of instructions. Examples of suitable networks include networks including wired and wireless communication technologies, networks operating in accordance with any suitable networking and/or communication protocol, private intranets and/or the Internet.

The multi-tenant enterprise information system 108 may include multiple processing tiers or layers including a user interface layer 116, an application layer 120, and a data storage layer 124. The user interface layer 116 may provide tenant specific dashboards 128, including graphical user interfaces and/or web-based interfaces. A dashboard user interface may be advantageous for presenting enterprise information to users in a compact form. Such enterprise information may include information provided by enterprise information components such as an enterprise resource planning (ERP) component 140 and/or a customer relationship management (CRM) component 142. Different users may have different access rights to enterprise information as configured by an administrative user interface 126, and which may be defined in whole or in part by data contained in a user profile 132. User profiles 132 may have an administrator configured portion and a user configured portion (e.g., user configurable preferences). The tenant dashboard user interfaces 128 may include a default user interface for the service, as well as one or more user interfaces customized by tenants of the service. As noted, the dashboard user interfaces 128 interact with various ERP applications 140 and/or CRM applications 142 for providing users with relevant information. The components of the application layer 120 may access data storage layer 124 to obtain the necessary data for an application and/or to access a user profile 132 to determine what data to provide to a user (e.g., based on the user's position within an organization, the user's access or security rights, etc.). The data storage layer 124 may include a core service data store 131 as well as a data store (or data stores) 136 and 138 for storing tenant data (such as ERP, CRM, and/or eCommerce data). Data stores may be implemented with any suitable data storage technology, including structured query language (SQL) based relational database management systems (RDBMS). Each tier or layer (i.e., 116, 120, or 124) may be implemented by a distributed set of computers and/or computer components including computer servers. Enterprise Information System 108 may also be described as a multi-tenant data processing environment or platform in which each of the multiple tenants are able to store relevant business related data and work with the administrator of the environment to have one or more desired data processing operations performed on the data.

As known in the art, both functional advantages and strategic advantages may be gained through the use of an integrated business system comprising ERP, CRM and other business capabilities, particularly where the integrated business system is integrated with a merchants eCommerce platform and/or “web-store.” For example, a customer can searching for a particular product can be directed to a merchant's website and presented with a wide array of product and/or services from the comfort of their home computer, or even from their mobile phone.

When a customer initiates an online sales transaction via a browser-based interface, the integrated business system may process the order, update accounts receivable, update inventory databases and other ERP-based systems, and may also automatically update strategic customer information databases and other CRM-based systems. These modules and other applications and functionalities may be seamlessly integrated and executed by a single code base accessing one or more integrated databases as necessary, forming an integrated business management platform, and this integration can be further leveraged to provide additional advantages by incorporating inter-module communications.

However, each merchant is unique, both in terms of their commercial offerings, desired customer demographics, and marketing techniques, but also in terms of their internal business organization and philosophies. Therefore, a truly robust integrated business solution (such as an enterprise data processing platform or multi-tenant data processing environment) should not only have a rich set of features, but also be customizable for each business' needs. Thus, it is desirable to provide users of such a system with the ability to develop custom software applications that leverage the advantages of the functionality of an integrated business platform in the manner most desired by a particular user. Thus, the application tier 120 of the multi-tenant distributed computing system or platform 108 may provide an application server for executing customizable and/or extendible software applications, where such applications may be used to provide data in a desired format or to process data as may be desired by a particular tenant.

In order to improve efficiency and facilitate an employee's role within an organization, it would be advantageous to be able automatically provide users of the multi-tenant enterprise information system 108 with notifications and/or updates to the information stored in that multi-tenant data processing platform, where those notifications and/or updates are specific to a particular user's role within the enterprise. For example, it would be advantageous for a user's dashboard to display a data feed of activity within the multi-tenant enterprise information system 108 that is relevant to that particular user. Alternatively, it would be desirable to allow the multi-tenant information system 108 to interact with one or more 3rd party social applications 148 in order to provide users of those applications with a stream of information that is relevant to a particular user's role in an organization. However, conventional attempts to provide information and data from an enterprise information platform to a user of a social application have proven to be inefficient, ineffective, and/or have undesirable side effects or other drawbacks with respect to at least one significant use case.

For example, suppose that a user wants to be notified of the current open issue items that relate to customers that he/she is handling (such as for unresolved problems, requests for bids, issues in which some form of follow up is required, etc.). Typically, the user would need to perform a search for open issues and then save it at his “dashboard” internally, which may be the only way that he/she can access this kind of data. This requires work by the employee to formulate the search each time they are interested in the data, and then to take whatever steps are needed to make the search results available for access via the dashboard. Within a company employees may create user groups (e.g., Yammer accounts for the company) and they may collaborate on work projects using the user group. However, if a user wants to announce certain activities on both the platform dashboard and on the social media channel (e.g., Twitter, Yammer, Linkedln, etc.), they typically will have to duplicate the task of creating a post for each. Yet another disadvantage to conventional approaches to providing information and data from an enterprise information platform to a user of a social application is that if a record or data gets updated, then the user will not be notified in real time. This may prevent an employee from knowing about an important event for which they wished to be able to respond. To overcome this disadvantage may require use of a middle man or administrator whose is responsible for “watching” for data record updates and in response creating posts to the social media. However, this is an inefficient and possibly error-prone solution to the problem.

Embodiments of the invention solve these problems both individually and collectively.

### SUMMARY

This summary is a high-level overview of various aspects of the present methods and systems for modifying a scenario data set while maintaining internal data boundaries and introduces some of the concepts that are further described in the Detailed Description section below. This summary is not intended to identify key or essential features of the claimed subject matter, nor is it intended to be used to determine the scope of the claimed subject matter.

Embodiments of the invention are directed to a system, apparatuses, and methods for enabling the distribution of newly created data or updates to enterprise information as part of a user's social application feed. In some embodiments, the social application feed may be used as a distribution channel for the data and result in the data or a notification relating to the data being “posted” to a specified social application account of the user (e.g., Twitter, Linkedln, etc.). In at least one embodiment, the system includes a social subscription component, a social data storage component, a social content generation component, and a social user interface component. The social subscription component may be configured to receive instructions from a user that defines or identifies a specific source of desired information, data, updates, etc., and in response creates an enterprise information update rule. The social data storage component stores the enterprise information update rule(s). The social content generation component monitors updates to data stored in an enterprise information service (such as a multi-tenant data processing platform), evaluates the updates in terms of satisfying (or failing to satisfy) the enterprise information update rule(s), accesses data related to the updates (if the rule or rules are satisfied), and if applicable, generates social application posts pertaining to the updates for distribution and display to the user. The social user interface component may then be used to format and present the social application posts to the user.

In another embodiment, the invention is directed to a method for providing data and/or updates of relevant business information and data to a subscriber of a social application. The inventive method may include the steps of monitoring an enterprise information service for newly created data or updates to data stored therein. In response to detection of new data or an update to the data, the method then evaluates a rule or rules to determine if the data or update satisfies or fails to satisfy that rule or rules. In response to a rule being satisfied by the data or update, the data (new or updated) is accessed and a corresponding update to a social application feed is generated for presentation to the user.

In one embodiment, the invention is directed to a method of providing information contained in a multi-tenant information system to a user of the multi-tenant information system, where the method includes:

generating a profile defining the information and including one or more rules which, if satisfied, will cause execution of a process to provide the information to the user;

detecting an activity occurring within the multi-tenant information system;

evaluating the one or more rules to determine if the detected activity satisfies a condition defined by the one or more rules;

accessing the information contained in the multi-tenant information system if the detected activity satisfies the condition defined by the one or more rules;

formatting the information in accordance with a condition contained in the profile; and

posting the formatted information to a social application, thereby distributing the information to the user via a channel associated with the social application.

In another embodiment, the invention is directed to a system for enabling a display of an update to enterprise information in a social application feed, where the system includes:
(a) a social subscription component for receiving one or more instructions from a user pertaining to an enterprise information system entity, and in response creating an enterprise information update rule corresponding to the one or more instructions;
(b) a social data storage component for storing the enterprise information update rule;
(c) a social content generation component for monitoring one or more updates to data stored in the enterprise information system, testing the one or more updates against the enterprise information update rule, accessing data related to the updates if the enterprise information update rule is satisfied, and generating a post pertaining to the accessed data for distribution to the social application; and
(d) a social user interface component for formatting and presenting the post to the user.

In yet another embodiment, the invention is directed to an apparatus for providing information contained in a multi-tenant information system to a user of the multi-tenant information system, where the apparatus includes:

an electronic processor configured to access a non-transitory computer readable medium and programmed to execute a set of instructions;

the set of instructions stored in the non-transitory computer readable medium, wherein when executed by the electronic processor, the set of instructions cause the apparatus to implement a process for providing the information comprising

generating a profile defining the information and including one or more rules which, if satisfied, will cause execution of a process to provide the information to the user;

detecting an activity occurring within the multi-tenant information system;

evaluating the one or more rules to determine if the detected activity satisfies a condition defined by the one or more rules;

accessing the information contained in the multi-tenant information system if the detected activity satisfies the condition defined by the one or more rules;

formatting the information in accordance with a condition contained in the profile; and

posting the formatted information to a social application, thereby distributing the information to the user via a channel associated with the social application.

Other objects and advantages of the present invention will be apparent to one of ordinary skill in the art upon review of the detailed description of the present invention and the included figures.

### BRIEF DESCRIPTION OF THE DRAWINGS

Various embodiments in accordance with the present disclosure will be described with reference to the drawings, in which:

FIG. 1 is a diagram illustrating elements of an example computing environment 100 in which an exemplary embodiment of the inventive system and methods may be implemented;

FIG. 2 is a diagram illustrating elements of an example computing environment 200 that includes components that may be used to implement an embodiment of the inventive system and methods;

FIG. 3 is a diagram illustrating a user of an enterprise information system interacting with an embodiment of the inventive system, where in response to an update to a record in the CRM database, one or more social application feeds are updated;

FIG. 4 is a flowchart or flow diagram illustrating an example set of steps that may be used to implement an embodiment of the inventive system and methods;

FIG. 5 is a diagram illustrating elements that may be present in a computing device and/or system 500 that is capable of implementing one or more of the methods, processes, functions, or operations described herein, in accordance with an embodiment of the invention; and

FIG. 6 is a diagram illustrating an example process flow 600 for the “posting” of data or an update to data that is part of an enterprise business information system to one or more social applications.

### DETAILED DESCRIPTION

This description discusses various illustrative embodiments of the present system, apparatuses, and methods for enabling data sharing capabilities with social applications for an enterprise information system, and is presented with reference to the accompanying drawings in order to provide a person having ordinary skill in the relevant art with a full, clear, and concise description of the subject matter defined by the claims which follow, and to enable such a person to appreciate and understand how to make and use the same. However, this description should not be read to limit the scope of the claimed subject matter, nor does the presence of an embodiment in this description imply any preference of the described embodiment over any other embodiment, unless such a preference is explicitly identified herein. The term “exemplary” as used herein is used to indicate an illustration of a thing's general characteristics, and not to indicate an ideal or otherwise preferred example of that thing. It is the claims, not this description or other sections of this document or the accompanying drawings, which define the scope of the subject matter to which the inventor and/or the inventor's assignee(s) claim exclusive rights.

In accordance with at least one embodiment of the present system and methods, an enterprise information system (such as a multi-tenant data processing platform) having the capability to facilitate the acquisition, processing, and storage of information specifically related to business entities, such as one or more of sales, finance, customer service, or eCommerce information is provided. Further, elements or components of the inventive system are capable of enabling interaction with one or more social networking applications (e.g., a social network application data feed), thereby providing a method for distributing specific enterprise related data or information through a social network application to a subscriber or member of the social network. Conventional social network applications enable people to interact and share information within a virtual space. In the context of the inventive enterprise information system, certain elements may be used to integrate business entity data with social-networking type posts. In this regard, embodiments of the present system and methods provide a solution to the lack of automatic integration between real time updates of the business entity data (such as sales information, customer updates, financial results, etc.) and distribution of that data to a feed for a social network application. This provides a benefit for users, as without such integration, a user may have to continuously check a voluminous amount of business entity data for changes, and then manually post each update using a social networking application in order to propagate the information to a desired social network or networks.

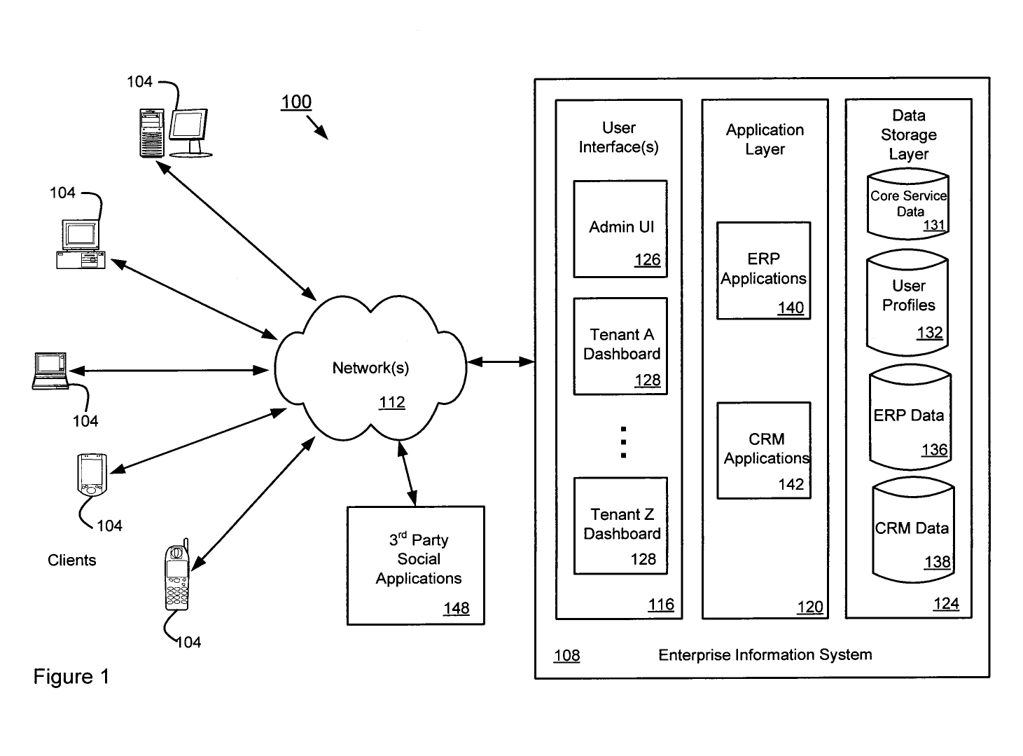

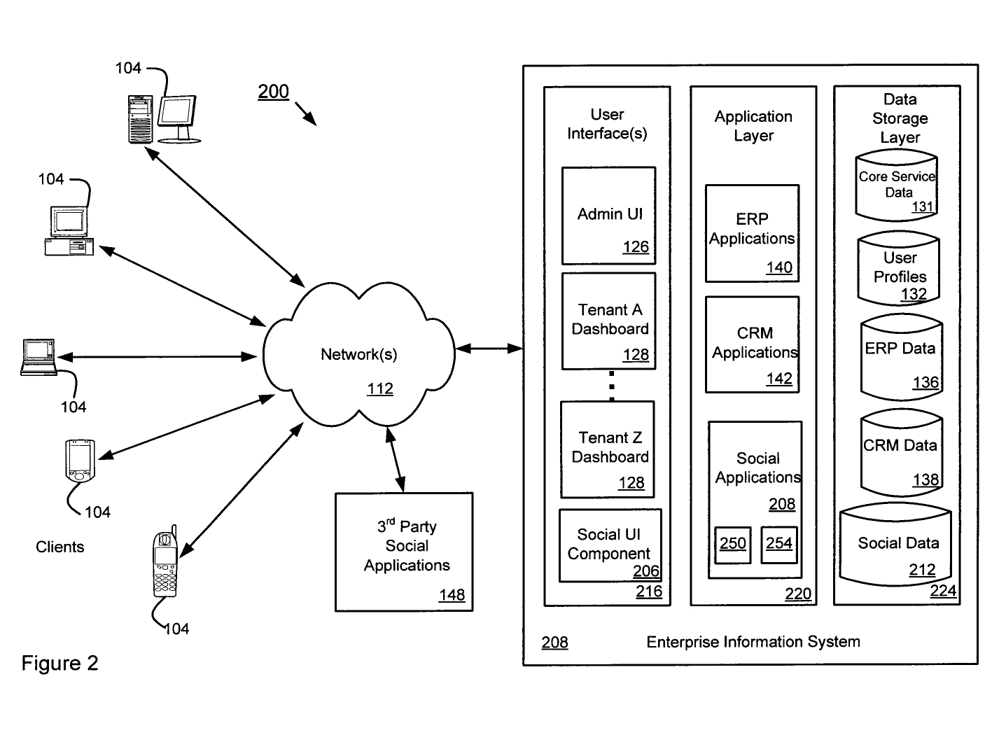

FIG. 2 is a diagram illustrating elements of an example computing environment 200 that includes components that may be used to implement an embodiment of the inventive system and methods. As in the conventional environment described above with reference to FIG. 1, a variety of clients incorporating and/or incorporated into a variety of computing devices 104 may communicate with an enterprise information system or platform 208. In addition to the standard components found in the user interface 216, application 220, and data storage 224 layers, the inventive enterprise information system 208 may include one or more social network related components, including a social user interface 206, one or more social applications 208, and a social network data database 212. Persons of ordinary skill in the art will recognize that while various components of the inventive enterprise information system 208 may have generally analogous counterparts in a conventional enterprise information system (such as that described with reference to FIG. 1), such components may have supplemental capabilities and features directed to interconnection and cooperation with the social network related components found in the inventive system, as described in greater detail below.

Users of the enterprise information system 208 may utilize client applications that are interfaced with (or otherwise coupled to) user interface components to follow (i.e., subscribe to newly created data or updates from) any suitable enterprise information system tenant or entity, including accessing various data metrics related to such entities. An enterprise information system “entity” can be a set or category of enterprise data, and may be defined in terms of the data accessible to one or more of the social applications 208. For example, data pertaining to a particular customer of a tenant or to a particular organizational aspect of a tenant may correspond to an enterprise information system entity, while data pertaining to a particular type of user (such as a sales representative) may correspond to a different enterprise information system entity. When a user indicates he/she wishes to follow a particular enterprise information system entity, for instance via a social application user interface, a social subscription component 250 of the social applications component 208 may create an entity subscription for that user in the social information database 212. Such subscriptions may specify conditions and/or triggers that result in social content generation and/or distribution of entity related content to a 3^{rd} party social application channel. Upon occurrence of a suitable condition or triggering event, a social content generation component 254 may access the social information database 212, look up subscriptions for one or more users, and use the specified conditions and/or triggers to identify and access the necessary enterprise data. Such data may for example be stored in the ERP and/or CRM databases 136, 138. After accessing the desired data, social content generation component 254 may generate desired content for presentation to the user via an integrated social user interface 128 (e.g., a social feed channel within a user's dashboard) and/or via a third-party social application 148.

In accordance with embodiments of the inventive system and methods, users may use the social subscription component 250 to subscribe to social channels or feeds to which pre-defined categories of social content may be automatically posted (news, business events, commentary, etc.). Users may instead or in addition optionally create, view, update and delete channels, as well as add or remove channels from a user interest list. As noted, users may also optionally elect to subscribe to particular business entities and thereby to receive data regarding business organizations, performance, etc. Social content (i.e., data formatted and prepared for delivery via a social application or social distribution channel) generated according to the user's selections may be presented via a feed or stream in the user's dashboard and/or a separate social application. Users may elect to receive separate notifications of updates to their social feed, for example via email, text notification, and/or push notifications.

In accordance with embodiments of the inventive system and methods, users may opt to follow business entities they are involved in, part of, or have an interest in by “subscribing” to those entities' social network feeds. For example, a company's sales representative may want to track news or business updates on all of the company's customers. In such a situation, the subscription mechanism 250 may be advantageously be applied to all activities and updates related to the business entity, or to a subset, as specified by the user. For example, when a customer submits a request for technical support, the sales representative assigned to that customer may opt to receive updates on the status of the request.

In accordance with embodiments of the inventive system and methods, users may follow/subscribe to real time updates of business data and channels specified by the user, even though such data and/or channels may not be directly related to the user. Aspects of the inventive system and methods may also allow users to schedule receipt of business metrics using the user's own social feed. Thus, if a sales representative wishes to know how many leads are assigned to him/her each week, he/she can schedule those updates to be posted to his feed at a regular interval, e.g. every Monday morning.

As mentioned, a user of an enterprise information system may rely on one or more “dashboards” to monitor key organizational metrics that are relevant to their job or related responsibilities. In accordance with embodiments of the inventive system and methods, dashboard content may be published to a social feed and thereby distributed by means of a channel associated with a social application. Threshold and/or conditional rules may be used to determine when particular data or a “dashboard element” should be updated (or initially distributed) to a social feed. When such a threshold/condition is met, one or more actions may occur. For example, a post may be sent to a user's or set of users' social news feeds. The post may summarize the condition that was met in order to display the post. A visual representation (such as a chart or graph) of live data may be displayed in a modal popup by clicking on the post, thereby allowing the user to view the information without having to leave the context of the social news feed. Traditional dashboard portlet interactions, e.g. drilling for more detail on a segment of the chart/graph and initiating follow up actions (sharing/sending emails) may also be supported (e.g., from the modal dialog).

In accordance with embodiments of the inventive system and methods, a mechanism for configuring a user's subscription to updates of data or information related to one or more business entities may be implemented. For example, there may be a desire to materialize an object or objects that are to be used as part of a posting to a social application in order to have a more efficient and cost effective retrieval method of subscription related data for users. For example, instead of running a search or searches each time a user views their social application postings (with links to the posts created during the post creation), the inventive system may instead retrieve all information relevant to the user via the links created.

In accordance with embodiments of the inventive system and methods, a user and/or system administrator may be enabled to configure a trigger or condition related to a portlet or business metric that appears on the user's dashboard. When the trigger or condition is satisfied, a post may be made to the relevant social feed (and thereby distributed to the user via the corresponding social application). The post may summarize the situation that led to satisfaction of the trigger or condition, and a link may be provided to display a real-time or pseudo real-time graphical representation of the relevant data.

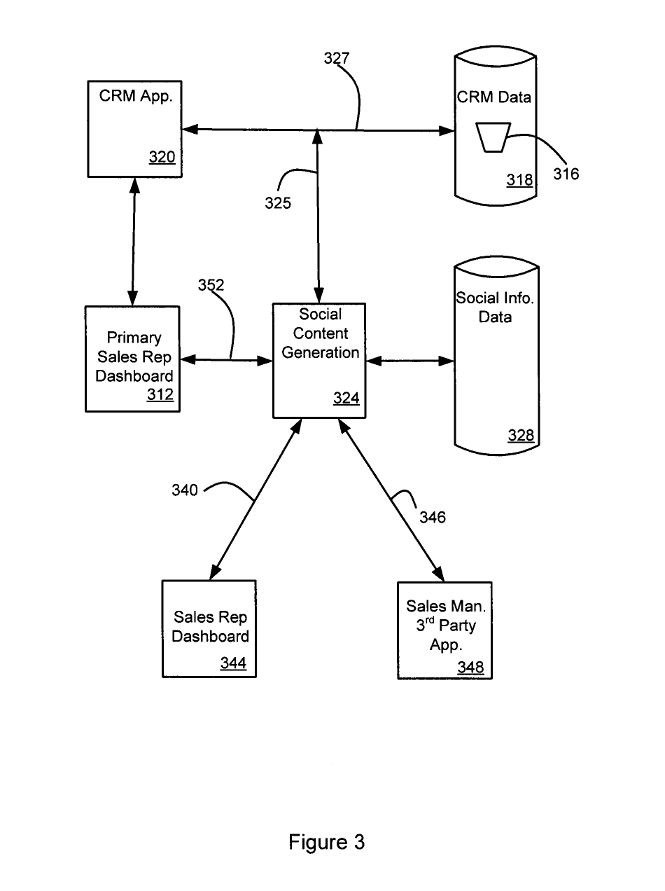

FIG. 3 is a diagram illustrating a user of an enterprise information system interacting with an embodiment of the inventive system, where in response to an update to a record in the CRM database (where note that the updated database or other form of data store could contain ERP data, eCommerce data, or other type of data for which a user wishes to be kept aware of updates), one or more social application feeds are updated. As shown in the figure, a primary sales representative 312 may configure a subscription 316 requesting access to certain information or data relevant to an entity account, where data relevant to that entity is stored in CRM database 318. In some cases the user may be permitted to select the parameters of the subscription (such as data types, entity identity, frequency of update, etc.), while in others a user may be presented with a set of pre-configured subscriptions and be able to select those they desire to subscribe to (such as their company's current total sales, current monthly revenue, current inventory of a certain item, the number of eCommerce platform transactions for a specific item during the current month, etc.). In the case of a subscription related to CRM data, the subscription definition may be stored in CRM database 318, which obtains data from and provides data that is processed by CRM application 320. CRM application 320 may be one of a set of business related applications that are resident on a business enterprise information platform that is operated as a web-service or SaaS model.

The social content generation component 324 (which in one embodiment corresponds to element 254 of FIG. 2) may use a suitable process 325 to monitor the CRM application's interactions 327 with the CRM database 318. These interactions (which may include data access requests, data storage activities, data manipulations, etc.) are evaluated or “tested” against (or otherwise compared to) one or more social content generation rules. The social content generation rules are one or more rules (e.g., a rule set) or other suitable form of defining a way to identify the desired information or data in order to fulfill a request by a user for certain information related to an entity (such as may be associated with a specific subscription 316). Note that the rules associated with subscription 316 relate to data and events that are part of the CRM application and database. Although not shown, a user may similarly wish to subscribe to data and events that are part of another application, such as an ERP or eCommerce application (or other source of data and events on the enterprise business information system platform) and its associated data, with such a subscription being associated with an applicable rule set.

Note that a set of subscriptions organized according to subscriber identity may be stored in the social information database 328. That is, for each subscriber user there may be an associated set of subscriptions to one or more entities (i.e., sources of information) and hence to data being accessed, stored, or updated in one or more data bases (such as CRM, ERP, etc.) by one or more applications (e.g., a CRM application, ERP application, eCommerce application, etc.), along with an indication of the appropriate rule set to use to determine the desired information. Similarly, social information database 328 may store one or more subscriptions organized by type or object of the subscription (such as organized by the entity subscribed to) and including all users subscribing to that entity, along with an indication of the appropriate rule set to use to determine the desired information.

For example, a user who is a sales representative may subscribe to a channel of information 340 via his/her dashboard 344, with the data provided being directed to all activities relating to a particular customer (which data would be processed by CRM application 320, with data being accessed, stored, and/or updated in CRM database 318, and which would be distributed using the elements and processes of one or more embodiments of the invention). Similarly, a sales manager may subscribe to updates related to a set or group of certain subscription entities 346 (such as for a set of employees and/or customers) via a third party social application 348 (where such data would be distributed using the elements and processes of one or more embodiments of the invention). Further, a primary sales representative 312 may subscribe to updates 352 related to certain event notifications that are relevant to his/her performance metrics. Thus, in accordance with some embodiments of the inventive system and methods, in response to the CRM application 320 accessing, generating, updating, or storing data in the CRM database 318, each relevant subscription (e.g., 316 or other rule base or rule set contained in one or more of CRM database 318, social information data 328, or other suitable element) may cause the social content generation component 324 to generate a corresponding news feed/subscription post to the relevant user (where such generating of a news feed or post is the result of evaluating one or more rules, conditions, etc. that define what information or data is to be provided in order to satisfy the terms of a subscription).

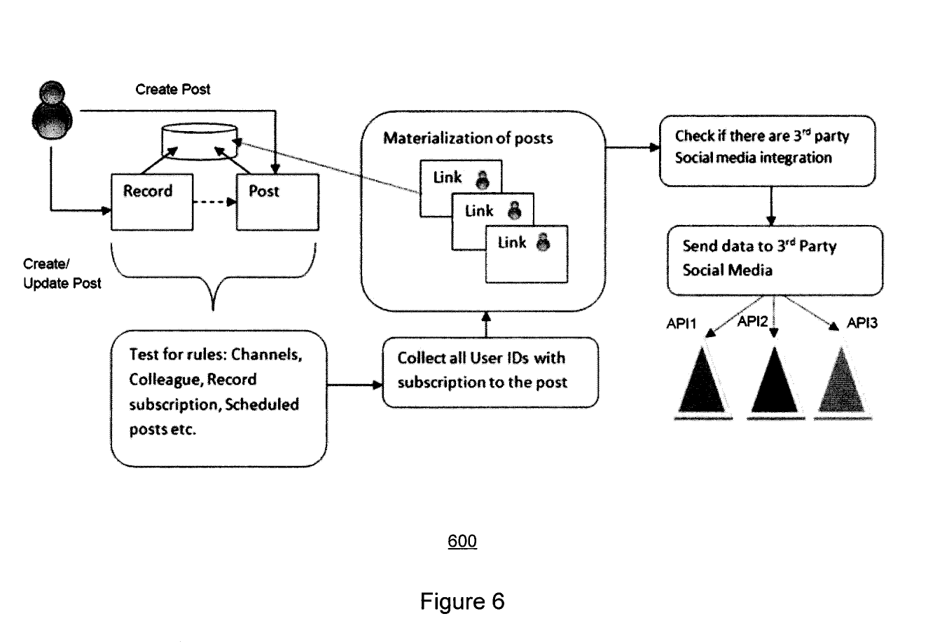

FIG. 6 is a diagram illustrating an example process flow 600 for the “posting” of data or an update to data that is part of an enterprise business information system to one or more social applications. As shown in the figure, a posting to a social application feed may result from a process such as:

A. For a manual posting to a feed
(1) A user creates a post and saves it;
(2) The post will be saved in a record or file (indicated as “Record” in the figure);
(3) Prior to, or as part of, the save operation, the record may be “tested” and/or evaluated in terms of satisfying or not satisfying one or more rules or conditions (e.g., the people subscribed to the channel where the content is posted, the users following the person who authored the post, determining if there are records within the post that other users are subscribed to, etc., as indicated by “Test for rules” in the figure);
(4) After such “testing” of the proposed post, the list of users eligible to receive or otherwise access the post will be obtained (as indicated by “Collect all User IDs with subscription to the post” in the figure);
(5) A link record will be created containing the post record ID and the user ID (as indicated by “Link” in the part of the figure labelled “Materialization of posts”); and
(6) A process to check if there is a third party social media application or platform integrated with the overall process (as indicated by “Check if there are 3^{rd} party Social media integration” in the figure). If so, each user will be sent the information corresponding to their subscription in a manner dependent upon the 3^{rd} party social media application or platform they have specified (or which is chosen by default). This may be accomplished by accessing the appropriate social media application API to provide the content that the user will receive (as indicated by “Send data to 3^{rd} party Social Media” in the figure).
   B. For an automatic posting, for example as a result of the operation of a subscription rule or rules (or other type of condition)
(1) A user creates and/or updates a record;
(2) A post will be saved in the record (i.e., the post will be seen by the user who created/updated the record);
(3) The created/updated record is checked to determine if it is associated with a rule or rules (or other form of condition);
(4) If there is a rule or rules associated with the record, then a process is used to identify all users who are subscribed to the rule or rules;
(5) A link record will be created containing the post record ID and the user ID; and
(6) A process to check if there is a third party social media application or platform integrated with the overall process. If so, each user will be sent the information corresponding to their subscription in a manner dependent upon the 3^{rd} party social media application or platform they have specified (or which is chosen by default). This may be accomplished by accessing the appropriate social media application API to provide the content that the user will receive.

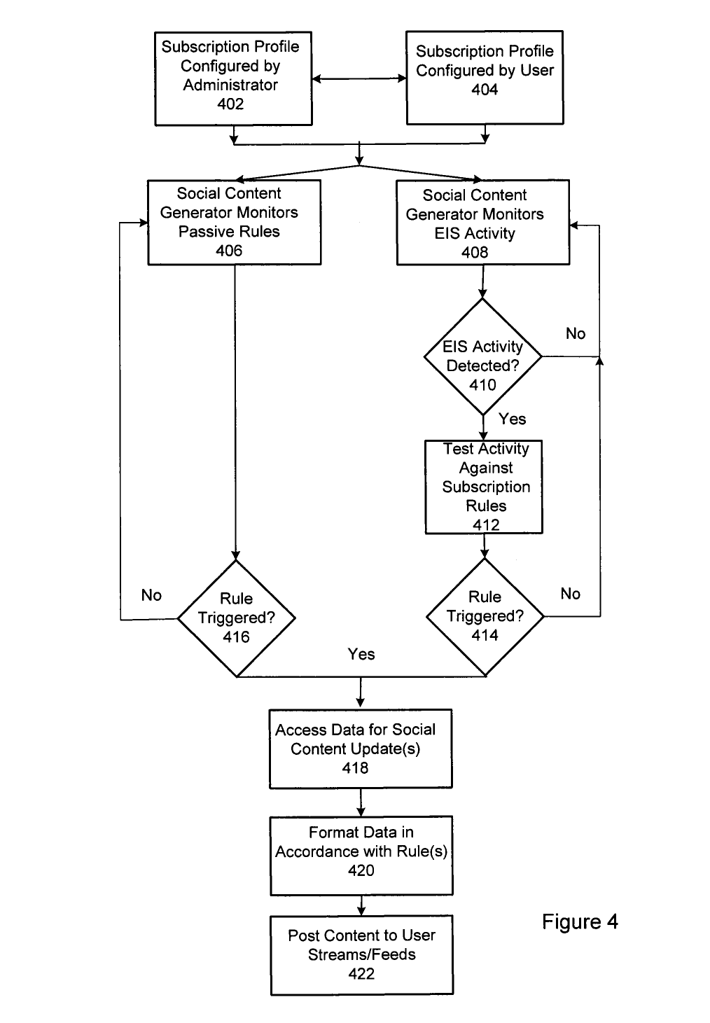

FIG. 4 is a flowchart or flow diagram illustrating an example set of steps that may be used to implement an embodiment of the inventive system and methods. For example, some or all of the steps, functions, or operations depicted in FIG. 4 may be performed by the components of enterprise information system (EIS) 208 shown in FIG. 2. In such a situation, one or more of the processes, methods, functions, or operations corresponding to the steps or stages illustrated in FIG. 4 may be implemented by a suitably programmed processor, such as a microprocessor or CPU. The programmed processor will execute a set of instructions that cause an apparatus incorporating the processor to implement one or more of the processes, methods, functions, or operations corresponding to the steps or stages illustrated in FIG. 4.

As shown in the figure, a user subscription profile may be created (i.e., defined) and configured by an administrator 402 and/or individually configured by the user 404. That is, a user (such as an employee of an entity that utilizes the EIS) may define certain parameters of a desired subscription independently or with the assistance of a system administrator (for the EIS and/or the entity). Similarly, a system administrator may define certain parameters of a desired subscription independently or with the assistance of the user for whom the subscription is intended. In some embodiments, social subscription component 250 of FIG. 2 may be used to perform some or all of the configuration process.

A subscription profile for a user may define certain parameters or characteristics that can be used to identify the data or types of data that are of interest to the user, and that the user wishes to be distributed to them using one or more social applications. For example, a user profile may specify the user's access rights to various types and levels of enterprise information, as well as preferences for how that data should be distributed and presented to the user (such as a preferred social application communications channel). Note that subscriptions to an entity of an enterprise information system (EIS) will typically be intended to provide data or information (such as the result of processing system data) related to the operations or status of a business or employee of a business. A subscription may be configured as part of the initially specified user-access framework or by another suitable method. A subscription may be automatically defined and configured, and/or represent a default subscription for a particular user type (such as a subscription based on the role of the user with an organization or group). A subscription may be configured due to evaluation of an associated social network graph (e.g., enabling an automatic subscription to members of a team, social group, etc.) and/or an associated enterprise organizational graph (e.g., enabling an automatic subscription to members of a functional group within an organization, etc.). A subscription may be added due to an explicit user action (e.g., clicking “follow” as part of a social application) and/or automatically executed rules in a user's profile (e.g., a salesperson may have a rule that causes them to automatically follow the activities of all customers).

After a user's profile has been configured or reconfigured (as depicted in steps 402 and 404, either alone or in combination), the social content generation component (e.g., element 254 of FIG. 2) monitors the activity 408 of other components of the enterprise information system. In response to the activity of such components (e.g., a write operation to one or more of the CRM or ERP databases, a transaction occurring as part of an eCommerce platform, as depicted by the “Yes” branch of step 410), the social content generation component may evaluate the activity against one or more of the social application subscription rules defined as part of configuring the applicable user profile(s), and which may be stored in the social database (as depicted by step 412 of FIG. 4). If no activity is detected (as depicted by the “No” branch of step 410), then the system continues the monitoring process (as depicted by step 408).

Note that embodiments of the inventive system and methods may include providing social application distribution channels related to one or more predefined categories of enterprise information system entity data. These channels may have their own rule set or evaluation process, and the social content generation component may test the activities of enterprise information system components against these rule sets, in a similar manner to that described for user profile configured rules or evaluation processes.

If an activity does not trigger a user profile or channel defined rule (as depicted by the “No” branch of step 414), then the social content generation component may take no action and return control to the monitoring process depicted by step 408. Note that in parallel with the activity-based social application channel updates described with reference to steps 408-414, the social content generation component may also monitor additional, passive rules as defined by one or more user profiles 406, such as time/date based rules intended to trigger the distribution of data or information in accordance with a schedule. In the event that either a passive rule (as depicted by the “Yes” branch of step 416) or an activity-based rule (as depicted by the “Yes” branch of step 414) is satisfied or “triggered”, the social content generation component may generate one or more social content updates, such as a news feed post or channel update.

As noted, when either a passive or activity-based rule or condition is satisfied, the inventive system and methods will act to generate an update or posting to one or more social application channels. The content for the update or posting may be generated based on data or information accessed by the system (as depicted by step 418), where that data or information may be stored in a database or other data storage element that is part of the EIS. In addition, the data or information may be generated by processing operations implemented by the EIS, such as the generation of a dashboard element. The accessed data or information may be formatted and/or processed for presentation in accordance with specified user and/or channel preferences (as depicted by step 420) and then added (e.g., “posted”) to the relevant social content stream(s) or feed(s) (as depicted by step 422). For example, the subscription profile may specify the appropriate social content stream and/or the social content generation component may determine one or more relevant social content streams to which the generated social content is then added.

In accordance with at least one embodiment of the inventive system and methods, a flexible business based social networking tool with the capability of generating automated and/or customized subscriptions to a business entity is enabled. For example, embodiments of the inventive system and methods enable a user to select what type of updates will be visible on the users' dashboard. This may make the user's interaction and sharing of information more convenient when dealing with business records that the user is working with. In accordance with at least one embodiment of the inventive system and methods, instead of going through individual records to determine changes to data that have occurred, real-time updates may be presented on a dashboard. For example, the invention may provide a user with one-click access to a record that has changed/created. If a user does not have access to the dashboard, then the user can still be informed of changes to data or information via email or another notification mechanism.

In accordance with one or more embodiments of the inventive system and methods, a user does not have to proactively navigate to a Dashboard in order to monitor a desired source of data or information; instead, it is presented to them when generated and/or needed in accordance with a profile or rule set. This enables a user to focus on the important metrics that require their attention without being overloaded with additional information. As a result, many typical enterprise tasks that would require a user to navigate to a Dashboard to monitor data (and then follow up accordingly) can now be supported within the context of a social feed. This may permit a user to bypass accessing a traditional dashboard or enterprise application.

Some additional example use cases or examples of use situations for an embodiment of the inventive system and methods are the following:
a. Tracking of milestone announcements, i.e., reaching a goal—an example would be a post that indicates the number of Customers for a company. The administrator may configure a search for the number of Customers and define a rule so that when the number reaches a certain value, a post is created. This post announces that the company has reached a goal, and may announce it with use of other social media content and channel(s) for purposes of a promotion;
b. Human Resources within a company would like to announce a company event. By posting in a channel, the employees may be readily informed of the event, either by the social media within the platform or by the integrated social media;
c. Members of a cross-department (or even cross-company) project team:
   a. A project leader may wish to create a new ‘space’ or group for a team so that the leader can exchange information with them;
   b. A project leader may wish to more easily control who can access the space/group;
   c. An employee may wish to be associated with a project and/or follow/subscribe to content about the project's events or records;
   d. An employee may wish to ‘broadcast’ information about a project, with that broadcast appearing in an activity feed of other users who are part of the project; and
   e. An employee may wish to directly correspond with other users associated with the project and be able to tracks/associate that correspondence with the project record, such as:
      i. Ask for/share status updates;
      ii. Ask for additional information/clarification;
      iii. Share tips and tricks learned as part of the project;
      iv. Ask for help with a problem related to the project; and
      v. Communicate ‘hand off’ details to another user taking over some aspect or aspects of the project.
         Note that such communications may take any suitable form, including that of short messages (SMS) or posts, links, or files.

In addition to the above use cases or those described previously, embodiments of the inventive system and methods may provide advantages to users and organizations because of the ability to “leverage” the multiple business related applications and data sources that are accessible via an enterprise business information system. For example, a manager may be interested in following events and/or information about an entity that is based on multiple data sources or business information systems, or that is based on events or conditions occurring within more than one business information system:
a. An account manager can choose one or more of the following:
   Can follow their customers and see all key activity about them (and interactions with my company) as it is happening (in their own activity feed), such as
      A customer entered a support case, or
      A customer entered an enhancement Request.
   Since the manager has a list of activities for this, they can follow up with the different departments that handle the cases or requests the customer has filed.
b. A sales person can choose one or more of the following:
   They can track the items sold via a web store or via the platform itself; or
   They can track if the items are sold out or would need restocking to fulfill an order, and if so, forward the order to the appropriate person.
      Note that in this example, the tracking function and the response can be performed rapidly because the user will not need to be logged into the platform itself.

Other example use cases in which a rule or rules may be constructed include:
a. A user can subscribe to a specific channel (for example, developers of a company may have created a specific channel for Development Tips, where only developers are allowed to read and write posts). This may be implemented as either
   a. An automatic subscription to a channel—all members specified in the channel automatically can read and write posts; or
   b. A non-automatic subscription to the channel—members must explicitly subscribe to the channel or have a certain profile to be able to read and write posts.
b. Subscription to a colleague—this is similar to a “Follow” function. A use case wherein a user will be able to read posts created or related to the specified colleague.
c. Subscription via record changes/updates
   a. A user creates a certain record—a post will be created if the record type allows an automatic posting upon creation process.
   b. A user modifies data within a certain record—if the data being modified is being “watched” or tracked, a post will be created indicating that the user has modified the data within that record (this may be executed by comparing the previous value to the new value saved by the user and applying one or more rules or conditions to trigger the posting).
   c. A user can follow/subscribe to a specific record. All updates/changes to that record that will cause a posting to a feed, which will be received by the subscribed user.
   d. A user may subscribe to a rule wherein he/she is a part of the data in the record (for example, “Customer” is the record type being created/updated. A customer record has data pertaining to its sales representative. The value for this sales representative is a person, which may be the user. In such a case, a rule may state: “I would like to follow or subscribe to all customer records wherein I am a sales representative”);
   e. A user may subscribe to a specific collection of data. The collection of data may be defined as a search where there are criteria and filters for fields that may be specified (for example, “I want to subscribe to all Issue records that have Priority data set to High”).
   f. A user may subscribe to a chain of rules based on transaction records. The user may opt to choose which transaction record(s) they will subscribe to. This record or records will then be detected when it is created/updated. It will be evaluated to determine if it contains data which the user has subscribed to, and if so, the post for that record will be provided to the user (for example, a user has an existing subscription for a customer—the customer creates an order (e.g., a sales order transaction)—the post corresponding to the creation of that Sales Order transaction will then be provided to the user.
d. There can be a scheduled rule, by which the inventive system will post a feed or other form of content which the subscribed users can then view in accordance with a defined schedule (for example, “Sales lead would like to post a feed every Friday with the number of leads closed for that specific week.” In this case, the post will be sent to all sales representatives for their reference).

The following provides additional information about the data that may be used to create or define a subscription to the indicated feature, content, etc. when using an embodiment of the invention (and in some cases refers to one or more of the use cases noted):
a. Channel subscription (examples of possible data, data types)
   i. User Name
   ii. ID
   iii. Active/inactive button
   iv. Auto Subscription—automatically set that all may read and write posts
   v. Filters relating to the user (such as Department, location, role, subsidiaries)
   vi. Individuals—allowed users who can view posts to that channel
   vii. Allowed Posters—set of users who are allowed to create content for the channel
   viii. Allow comments toggle—If comments to feeds will be allowed or not
b. Colleague Subscription (examples of possible data, data types)
   i. Name of Colleague
c. Record Changes (examples of possible data, data types)
   i. Definition of which record type is included in the sending of feeds
   ii. Automatic post on creation data
   iii. Definition of tracked fields (i.e., a list of data fields within the record—once defined the fields are considered to be “watched” for changes). Fields of various types including text, integer, date, list records, checkboxes, and others may be relevant.
   iv. Name of subscription
   v. ID
   vi. Description of the rule or rules
   vii. Field data of the record where the subscription will be based (e.g., Sales Representative field of the Customer Record)
   viii. Restriction(s) on the rule (e.g., the rule will be restricted to users with Sales Person roles)
   ix. Saved search field (the system may have the ability to store searches and this field will serve as a link to a search that the subscription rule will apply to further filter use of the rule)
   x. Related record—this field is applicable to the chaining of rules—data to be specified should be the related record to the previous subscription (e.g., a user has an existing subscription to Customers where the user is a Sales Representative. The related record can have a value of Sales Orders. In such a situation, a chained rule may take the form of “Subscribe to Sales orders of Customers where I am a Sales Representative”)
   xi. Related record field—This is the data field where the previous record should appear in the related record.
d. Scheduled posts
   i. Name of the scheduled post subscription
   ii. ID
   iii. Active or inactive toggle
   iv. Saved Search—search that will define the summary field for the posting (e.g., “search for the number of lead records closed for this week”)
   v. Post text—format or other constraints on the post to be displayed
   vi. Schedule for posting—posting can be recurring or single instance
   vii. Channel or group of subscribers/users where the post will be visible
      The data descriptions or formats stated above are the subscription rules definition (in whole or in part). Once a user subscribes to a rule, the following data may be stored in the system as a link from the user to a rule:

a. User ID, channel ID

b. User ID, Colleague ID

c. User ID, Record Subscription rule ID

d. User ID, Scheduled post rule ID

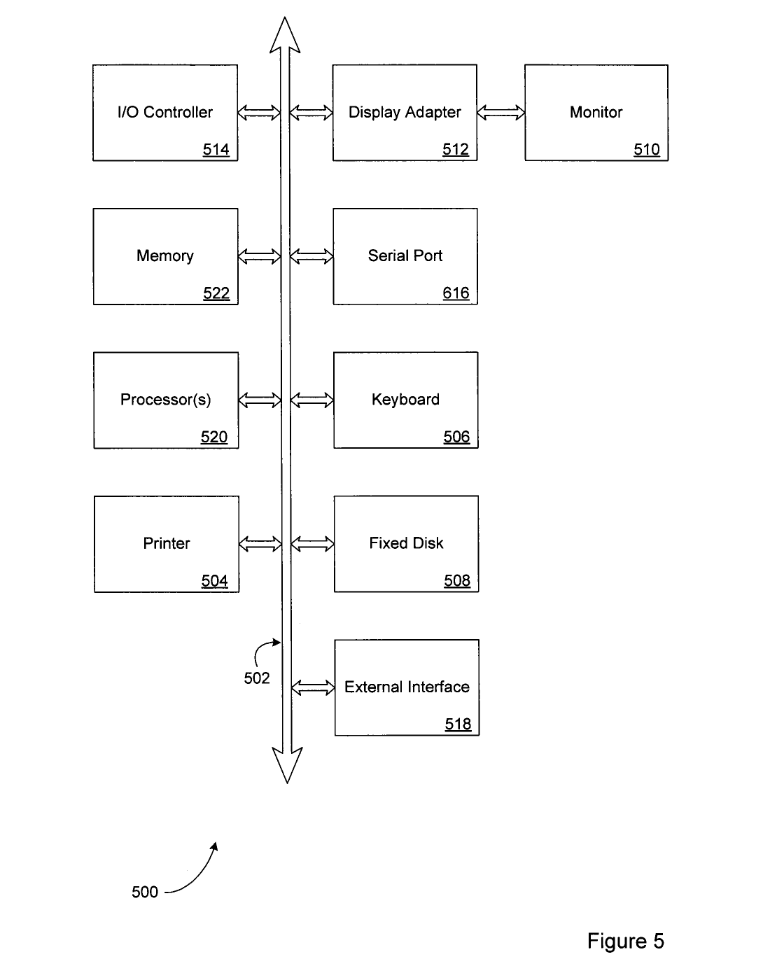

By way of a non-limiting example, FIG. 5 is a diagram illustrating elements that may be present in a computing device and/or system 500 that is capable of implementing one or more of the methods, processes, functions, or operations described herein, in accordance with an embodiment of the invention. Note that one or more of the components of computing device or system 500 may be part of a server, apparatus, data processor, or other suitable device. Typically, a system, apparatus, or device that includes one or more of the components of computing device 500 will be used to execute a set of instructions or commands which are represented by computer-executable software. The set of instructions may be stored in a suitable data storage medium. An electronic processor (such as a microprocessor or CPU) accesses the data storage medium to “read” the instructions and thereby to program the processor. When properly programmed, the processor may be used to cause the computing device to perform one or more of the processes, methods, functions, or operations described herein.

The subsystems shown in FIG. 5 are interconnected via a system bus 502. Additional possible subsystems include a printer 504, a keyboard 506, a fixed disk 508, and a monitor 510, which is coupled to a display adapter 512. Peripherals and input/output (I/O) devices, which couple to an I/O controller 514, can be connected to the computer system by any number of means known in the art, such as a serial port 516. For example, the serial port 516 or an external interface 518 can be utilized to connect the computer device 500 to further devices and/or systems not shown in FIG. 5, including a wide area network such as the Internet, a mouse input device, and/or a scanner. The interconnection via the system bus 502 allows one or more processors 520 to communicate with each subsystem and to control the execution of instructions that may be stored in a system memory 522 and/or the fixed disk 508, as well as the exchange of information between subsystems. The system memory 522 and/or the fixed disk 508 may embody a tangible computer-readable medium.

The various aspects and embodiments of the invention described herein are specific, but not exclusive, examples of how the inventive system and methods may be implemented and the advantages gained therefrom. However, persons having ordinary skill in the art will recognize that the teachings and descriptions herein are equally applicable to other embodiments and/or may be described using alternate terminology.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++, or Perl, using, for example, conventional or object-oriented techniques. The software code may be stored as a series of instructions, or commands on a computer readable medium, such as a random access memory (RAM) a read-only memory (ROM), a magnetic medium such as a hard-drive, a solid-state device such as a flash memory drive, or an optical medium such as a CD-ROM. Any such computer readable medium may reside on or within a single computational apparatus, and may be present on or within different computational apparatuses within a system or network.

Exemplary embodiments of the inventive system and methods have been described in detail herein and in the accompanying figures for illustrative purposes. However, the scope of the invention is defined by the included claims and is not limited to the embodiments described herein or depicted in the figures. Embodiments differing from those described and shown herein, but within the scope of the defined system, apparatus, and methods are envisioned by the inventors and will be apparent to persons having ordinary skill in the relevant art in view of this specification as a whole. The inventors intend for the described embodiments of the invention to be practiced other than as explicitly described herein. Accordingly, the protected embodiments encompass all modifications and equivalents of the subject matter as permitted by applicable law.

What is claimed is:

1. A method of providing information contained in a multi-tenant information system to a user of the multi-tenant information system, comprising:
generating a profile defining the information and including one or more rules which, if satisfied, will cause execution of a process to provide the information to the user;
detecting an activity occurring within the multi-tenant information system;
evaluating the one or more rules to determine if the detected activity satisfies a condition defined by the one or more rules;
accessing the information contained in the multi-tenant information system if the detected activity satisfies the condition defined by the one or more rules;
formatting the information in accordance with a condition contained in the profile; and
posting the formatted information to a social application, thereby distributing the information to the user via a channel associated with the social application.

2. The method of claim 1, wherein the information is one or more of ERP data, CRM data, or eCommerce platform data.

3. The method of claim 1, wherein the detected activity is one or more of a data write operation or a data storage access operation.

4. The method of claim 1, wherein the one or more rules included in the profile are defined by the user.

5. The method of claim 1, wherein the one or more rules include at least one rule that is satisfied independently of activity occurring within the multi-tenant information system.

6. The method of claim 5, further comprising:
evaluating the at least one rule to determine if a condition defined by the at least one rule is satisfied;
accessing the information contained in the multi-tenant information system if the condition defined by the at least one rule is satisfied;
formatting the information in accordance with a condition contained in the profile; and
posting the formatted information to a social application, thereby distributing the information to the user via a channel associated with the social application.

7. The method of claim 1, wherein the information is an update to data contained within the multi-tenant information system.

8. The method of claim 1, wherein at least a part of the profile is determined by the user's relationship to one or more members of a social network or to one or more members of a business organization.

9. A system for enabling a display of an update to enterprise information in a social application feed comprising:
(a) a social subscription component for receiving one or more instructions from a user pertaining to an enterprise information system entity, and in response creating an enterprise information update rule corresponding to the one or more instructions;
(b) a social data storage component for storing the enterprise information update rule;
(c) a social content generation component for monitoring one or more updates to data stored in the enterprise information system, testing the one or more updates against the enterprise information update rule, accessing data related to the updates if the enterprise information update rule is satisfied, and generating a post pertaining to the accessed data for distribution to the social application; and
(d) a social user interface component for formatting and presenting the post to the user.

10. The system of claim 9, wherein the social interface component transfers the post to a client application for presentation to the user.

11. The system of claim 9, wherein the social interface component transfers the post to a third party social application for presentation to the user.

12. The system of claim 9, wherein the one or more updates to data stored in the enterprise information system include an update to one or more of ERP data, CRM data, or eCommerce platform data.

13. An apparatus for providing information contained in a multi-tenant information system to a user of the multi-tenant information system, comprising:
an electronic processor configured to access a non-transitory computer readable medium and programmed to execute a set of instructions;
the set of instructions stored in the non-transitory computer readable medium, wherein when executed by the electronic processor, the set of instructions cause the apparatus to implement a process for providing the information comprising
generating a profile defining the information and including one or more rules which, if satisfied, will cause execution of a process to provide the information to the user;
detecting an activity occurring within the multi-tenant information system;
evaluating the one or more rules to determine if the detected activity satisfies a condition defined by the one or more rules;
accessing the information contained in the multi-tenant information system if the detected activity satisfies the condition defined by the one or more rules;
formatting the information in accordance with a condition contained in the profile; and
posting the formatted information to a social application, thereby distributing the information to the user via a channel associated with the social application.

14. The apparatus of claim 13, wherein the information is one or more of ERP data, CRM data, or eCommerce platform data.

15. The apparatus of claim 13, wherein the detected activity is one or more of a data write operation or a data storage access operation.

16. The apparatus of claim 13, wherein the one or more rules included in the profile are defined by the user.

17. The apparatus of claim 13, wherein the one or more rules include at least one rule that is satisfied independently of activity occurring within the multi-tenant information system.

18. The apparatus of claim 17, wherein the implemented process further comprises:
evaluating the at least one rule to determine if a condition defined by the at least one rule is satisfied;
accessing the information contained in the multi-tenant information system if the condition defined by the at least one rule is satisfied;
formatting the information in accordance with a condition contained in the profile; and
posting the formatted information to a social application, thereby distributing the information to the user via a channel associated with the social application.

19. The apparatus of claim 13, wherein the information is an update to data contained within the multi-tenant information system.

20. The apparatus of claim 13, wherein at least a part of the profile is determined by the user's relationship to one or more members of a social network or to one or more members of a business organization.
